(19) United States
(12) Patent Application Publication
(10) Pub. No.: US 2015/0109697 A1
(43) Pub. Date: Apr. 23, 2015

(54) COLOR FILTER AND DISPLAY DEVICE

(71) Applicant: Toray Industries, Inc., Chuo-ku, Tokyo (JP)

(72) Inventors: Ryo Nagase, Otsu-shi (JP); Tomonori Yamada, Otsu-shi (JP); Yoshihiro Ikegami, Otsu-shi (JP); Harushi Nonaka, Otsu-shi (JP)

(21) Appl. No.: 14/407,161

(22) PCT Filed: Jun. 13, 2013
(86) PCT No.: PCT/JP2013/066355

§ 371 Date: Dec. 11, 2014

(30) Foreign Application Priority Data
Jun. 22, 2012 (JP) 2012-140408

(51) Int. Cl. G02B 5/20; G02F 1/1335

(52) U.S. Cl. CPC G02B 5/201; G02F 1/133514
USPC 359/891

(57) ABSTRACT

The invention provides a colour filter wherein a black matrix is formed on a transparent substrate and pixels comprising red auxiliary pixels, green auxiliary pixels, blue auxiliary pixels and auxiliary pixels of a fourth colour are formed at the aperture of this black matrix or at the aperture of this black matrix and on this black matrix. The width (L1) of the black matrix between the aforementioned auxiliary pixels of the fourth colour and the other auxiliary pixels is to 4.5 μm. The auxiliary pixels contain respective colorant and resin. The tristimulus value (Y) according to the CIE1931 colour system of the aforementioned auxiliary pixels of the fourth colour is 70≦Y≦99.

### CROSS REFERENCE TO RELATED APPLICATIONS

This is the U.S. National Phase application of PCT/JP2013/066355, filed Jun. 13, 2013, which claims priority to Japanese Patent Application No. 2012-440408, filed Jun. 22, 2012, the disclosures of each of these applications being incorporated herein by reference in their entireties for all purposes.

### FIELD OF INVENTION

The present invention relates to a color filter and a display device.

### BACKGROUND OF THE INVENTION

Liquid crystal display devices take advantage of properties thereof, such as light weight, small thinness or reduced power consumption, to be used for various apparatuses, such as televisions, notebook personal computers, portable information terminals, smartphones, or digital assistants.

A color filter is a member necessary for allowing a liquid crystal display device to attain color display, and is generally a three-color color filter in which pixels each composed of three-color auxiliary pixels that are a red auxiliary pixel, a green auxiliary pixel and a blue auxiliary pixel are finely patterned (Patent Document 1). In the three-color color filter, a white color is obtained by additive color mixture of the auxiliary pixels of three colors of red, green and blue.

In recent years, as a means for improving a liquid crystal display device in transmittance, a four-color color filter has been proposed, in which pixels each having a white auxiliary pixel, in addition to auxiliary pixels of three colors of red, green and blue, are finely patterned (Patent Document 2). In this four-color color filter, the white auxiliary pixel contains no colorant to be transparent, and thus white light from a light source is used as it is, resulting in an improvement in transmittance. The transparent white auxiliary pixel is formed using a resin composition containing a polymerization polymer, a cationic polymerizable compound and a thermosensitive acid-generating agent.

In the meantime, as a method for improving a color filter in aperture ratio, a method of making a line width of a black matrix narrow to 1 to 2 μm has been proposed (Patent Document 3).

### PATENT DOCUMENTS

Patent Document 1: Japanese Patent Laid-open Publication No. 2004-309537

Patent Document 2: Japanese Patent Laid-open Publication No. 2012-83794

Patent Document 3: Japanese Patent Laid-open Publication No. 9-265006

### SUMMARY OF THE INVENTION

However, in order that a conventional four-color color filter improved in transmittance gains a brighter white color, it is necessary to use not only the chromaticity of a white auxiliary pixel, which is equal to the chromaticity of a color source, but also the chromaticity of a white color based on additive color mixture of auxiliary pixels of three colors of red, green and green. However, it is very difficult to make both the chromaticities equal to each other, namely, match both the chromaticities with each other. Thus, the color filter has the problem of being poor in white balance.

When a line width of a black matrix is made narrow for an improvement of a color filter in aperture ratio, white spots are easily generated so that there arises a problem that color shift due to the white spots are easily generated. Thus, an object of the present invention is to provide a color filter having a high transmittance, an excellent white balance and a high aperture ratio, and causing no color shift due to white spots.

Thus, the present inventors have made eager investigations, and as a result have found out that, for the white balance of a four-color color filter, not the chromaticity of an additively mixed color of auxiliary pixels of three colors of red, green and blue is one-sidedly matched with the chromaticity of a white auxiliary pixel, but the chromaticity of a white auxiliary pixel is simultaneously matched with the chromaticity of an additively mixed color of auxiliary pixels of three colors of red, green and blue, namely, the white auxiliary pixel is allowed to serve as an auxiliary pixel of a fourth color, which has a specified amount of a colorant and has a specified chromaticity.

The present inventors have further made eager investigations, and have found out that, about the shape of the color filter, while the difference in transmittance between each of the three colors of red, green and blue, and white spots is large in the red, green and blue auxiliary pixels so that color shift due to the white spots is largely affected, the difference in transmittance between the fourth color and the white spots is small in the auxiliary pixel of the fourth color so that the influence of color shift due to the white spots is small, and thus, a line width of a black matrix adjacent to the auxiliary pixel of the fourth color can be made narrow.

That is, the present invention includes a color filter and a display device described in the following (1) to (9):

(1) A color filter in which a black matrix is formed on a transparent substrate, a pixel including a red auxiliary pixel, a green auxiliary pixel, a blue auxiliary pixel and an auxiliary pixel of a fourth color is formed at an opening in the black matrix, or at the opening in the black matrix and on the black matrix, the line width L1 of the black matrix between the auxiliary pixel of the fourth color and each of other auxiliary pixels is from 0 to 4.5 μm, the auxiliary pixels each contain a colorant and a resin, and the tristimulus value (Y) of the auxiliary pixel of the fourth color according to the CIE 1931 color system is in the range of 70≦Y≦99.
(2) The color filter according to (1), wherein the line width L1B of the black matrix between the auxiliary pixel of the fourth color and the blue auxiliary pixel is from 0 to 3.5 μm.
(3) The color filter according to (1) or (2), wherein a relationship between the value L1 and the broadest line width L2 of the black matrix satisfies the following: 0≦L1/L2≦0.8.
(4) The color filter according to any one of (1) to (3), wherein in the pixel, the width L3 of the auxiliary pixel of the fourth color on the black matrix is from 0 to 2.0 μm².
(5) The color filter according to any one of (1) to (4), wherein the area of each of the auxiliary pixels of red, green, blue and the fourth color is from 240 to 3120 μm².
(6) The color filter according to any one of (1) to (5), wherein the concentration of the colorant in the auxiliary pixel of the fourth color is from 0.3 to 3% by mass.
(7) The color filter according to any one of (1) to (6), wherein the film thickness of the auxiliary pixel of the fourth color is from 0.8 to 2.0 μm.
(8) The color filter according to any one of (1) to (7), wherein the tristimulus value (Y) of the auxiliary pixel of the fourth color according to the CIE 1931 color system is in the range of 75≦Y≦90.
(9) A display device comprising the color filter according to any one of (1) to (8).

The color filter of the present invention can obtain a high transmittance and a good white balance, can prevent color shift due to white spots, and can be improved in aperture ratio.

The display device having the color filter of the present invention is high in both of transmittance and aperture ratio, and thus can be improved in light-use-efficiency.

### BRIEF DESCRIPTION OF THE DRAWINGS

FIG. 1 is a schematic view illustrating a cross section of a black matrix formed on a transparent substrate, the section being vertical to the longitudinal direction of an opening in the black matrix.

FIGS. 2(a) and 2(b) are, respectively, a cross section and a plan view of a CF model according to a first embodiment of the present invention.

FIGS. 3(a) and 3(b) are, respectively, a cross section and a plan view of a CF model according to an embodiment which is not according to the present invention.

FIGS. 4(a) and 4(b) are, respectively, a cross section and a plan view of a CF model according to a second embodiment of the present invention.

FIGS. 5(a) and 5(b) are, respectively, a cross section and a plan view of a CF model according to a third embodiment of the present invention.

FIGS. 6(a) and 6(b) are, respectively, a cross section and a plan view of a CF model according to a fourth embodiment of the present invention.

FIGS. 7(a) and 7(b) are, respectively, a cross section and a plan view of a CF model according to a fifth embodiment of the present invention.

### DETAILED DESCRIPTION OF EMBODIMENTS OF THE INVENTION

The color filter (hereinafter, “CF”) according to exemplary embodiments of the present invention is a color filter in which a black matrix is formed on a transparent substrate, a pixel including a red auxiliary pixel, a green auxiliary pixel, a blue auxiliary pixel and an auxiliary pixel of a fourth color is formed at an opening in the black matrix, or at the opening in the black matrix and on the black matrix, the line width L1 of the black matrix between the auxiliary pixel of the fourth color and each of other auxiliary pixels is from 0 to 4.5 μm, the auxiliary pixels each contain a colorant and a resin, and the tristimulus value (Y) of the auxiliary pixel of the fourth color according to the CIE 1931 color system is in the range of 70≦Y≦99.

By setting the tristimulus value (Y) (hereinafter, “(Y)”) of the auxiliary pixel of the fourth color according to the CIE 1931 color system in the above-mentioned range, the color filter can be improved in transmittance and white balance. By setting the line width L1 between the auxiliary pixel of the fourth color and each of other auxiliary pixels in the above-mentioned range, color shift due to white spots can be prevented in the red, green and blue auxiliary pixels, and the aperture ratio of each of the auxiliary pixels can be improved.

First, the transmittance and the white balance of the CF will be described.

The auxiliary pixels of red, green, blue and the fourth color each need to contain a colorant and a resin. The concentration of the colorant in the auxiliary pixel of the fourth color is preferably from 0.3 to 3% by mass, further preferably from 0.5 to 2% by mass, more preferably from 0.6 to 1.9% by mass. If the concentration of the colorant is less than 0.3% by mass, the CF may be poor in white balance. If the concentration of the colorant is more than 3% by mass, the CF may be lowered in transmittance.

The concentration of the colorant in each of the auxiliary pixels means the proportion of the colorant in the entire solid content in each of the auxiliary pixels. The concentration of the colorant in each of the auxiliary pixels can be adjusted in the above-mentioned range by controlling the mixing ratio of the colorant and the resin in preparation of a colorant composition. The concentration of the colorant in each of the auxiliary pixels can be measured by a method described hereinafter. First, about any auxiliary pixel to be measured, the colorant and the resin are extracted through a micro-manipulator. More specifically, as solvents, ethanol, chloroform, hexane, N-methylpyrrolidone and dimethylsulfoxide are each separately weighed in a weight of 99 mg. The colorant and the resin to be extracted, the amount of which is 1 mg, are then added to each of the solvents. The resultants are left to stand at 40° C. for 12 hours. The resin is extracted into each of the solvents, and then each of the solutions is filtrated to separate a solution of the resin and the colorant from each other. Next, a transparent and colorless solution, out of the resin solutions after the filtration, is weighed in a weight of 50 mg, and then left to stand at 150° C. for 5 hours to volatilize the solvent, drying the resin. Whether the resin solutions are each transparent or not can be determined as follows: the respective solvents are visually compared with the respective resin solutions after the filtration, respectively, and then a solution having no color difference, out of the resin solutions, can be determined to be transparent.

Next, in the case of using each of the solvents, the mass of the resin after drying is measured. The highest concentration value of the resin, out of the resultant concentration values, is defined as the resin mass A (A=0 to 0.50 mg). In accordance with expressions 1 and 2 described below, the resin concentration and the colorant concentration each can be calculated. By using a plurality of solvents as described above to make such a measurement, the accuracy of the measurement can be heightened.

Resin concentration (% by mass)=(A×2)/1 expression 1

Colorant concentration (% by mass)=(1−A×2)/1 expression 2

The concentration of the colorant in the red auxiliary pixel is preferably from 20 to 50% by mass. That of the colorant in the green auxiliary pixel is preferably from 30 to 50% by mass. That of the colorant in the blue auxiliary pixel is preferably from 15 to 40% by mass.

The tristimulus value (Y) of the auxiliary pixel of the fourth color according to the CIE 1931 color system needs to be in the range of 70≦Y≦99, and is preferably in the range of 71≦Y≦98, more preferably in the range of 75≦Y≦90. If the value Y is less than 70, the CF is lowered in transmittance. If the value Y is more than 99, the CF is poor in white balance. The value (Y) of the auxiliary pixel of the fourth color can be controlled in accordance with the kind, the mixing ratio and the concentration of the colorant used in the auxiliary pixel of the fourth color.

Examples of the colorant used in the auxiliary pixel of the fourth color include a pigment and a dye. Examples of a blue pigment include C.I. Pigment Blue (PB)-15, PB-15:1, PB-15:2, PB-15:3, PB-15:4, PB-15:5, PB-15:6, PB-16, and PB-60. Examples of a violet pigment include C.I. Pigment Violet (PV)-19, PB-23, and PV-37. Examples of a red pigment include C.I. Pigment (PR)-149, PR-166, PR-177, PR-179, PR-209, and PR-254.

Examples of a blue dye include 0.1. Basic Blue (BB)-5, BB-7, BB-9, and BB-26. Examples of a violet dye include C.I. Basic Violet (BV)-1, BV-3, and BV-10. Examples of a red dye include C.I. Acid Red (AR)-51, AR-87, and AR-289.

The hue of the auxiliary pixel of the fourth color can be selected from blue, red, violet, yellow, green, or bluish green. The hue is preferably light blue, light violet, or light red. More specifically, the chromaticity (x, y) of the auxiliary pixel of the fourth color according to the CIE 1931 color system, the chromaticity being measured by use of a C light source, (hereinafter, (x, y)), is preferably in the range of 0.250≦x≦0.305 and 0.285≦y≦0.315, more preferably in the range of 0.275≦x≦0.305 and 0.295≦y≦0.305. By setting the chromaticity in the range, the white balance and a high transmittance of the CF is easily satisfied at the same time.

Examples of the resin used in the auxiliary pixel of the fourth color include an acrylic resin, an epoxy resin, and a polyimide resin. A photosensitive acrylic resin is preferred since the resin can make production costs for the CF low. The photosensitive acrylic resin generally contains an alkali-soluble resin, a photopolymerizable monomer and a photopolymerization initiator.

Examples of the alkali-soluble resin include a copolymer of an unsaturated carboxylic acid and an ethylenic unsaturated compound. Examples of the unsaturated carboxylic acid include acrylic acid, methacrylic acid, itaconic acid, crotonic acid, maleic acid, fumaric acid, and vinyl acetate, and acid anhydrides thereof.

Examples of the photopolymerizable monomer include trimethylolpropane tri(meth)acrylate, pentaerythritol tri(meth)acrylate, triacrylformal, pentaerythritol tetra(meth)acrylate, dipentaerythritol hexa(meth)acrylate, and dipentaerythritol penta(meth)acrylate.

Examples of the photopolymerization initiator include benzophenone, N,N′-tetraethyl-4,4′-diaminobenzophenone, 4-methoxy-4′-dimethylaminobenzophenone, 2,2-diethoxyacetophenone, α-hydroxyisobutylphenone, thioxanthone, and 2-chlorothioxanthone.

Examples of the solvent for dissolving the photosensitive acrylic resin include propylene glycol monomethyl ether acetate, propylene glycol monoethyl ether acetate, ethyl acetoacetate, methyl-3-methoxy propionate, ethyl-3-ethoxy propionate, methoxybutyl acetate, and 3-methyl-3-methoxybutyl acetate.

In the case of using the photosensitive acrylic resin as the resin, a resin component including the alkali-soluble resin, the photopolymerizable monomer and a polymer dispersing agent, and the colorant are handled as the entire solid content.

As described above, the concentration of the colorant in the auxiliary pixel of the fourth color is far lower than that of the colorant in each of the red, green and blue auxiliary pixels. In order to cancel the difficulty in patterning of the auxiliary pixels, which is due to a low concentration of the colorant excellent in alkali resistance, it is preferred to set the mixing ratio by mass of the alkali-soluble resin and the photopolymerizable monomer in the auxiliary pixel of the fourth color in the range of 50:50 to 10:90. If the proportion of the alkali-soluble resin is more than 50% by mass, the auxiliary pixel of the fourth color may be cracked. If the proportion of the alkali-soluble resin is less than 10% by mass, a residue may be generated in an unexposed portion of the auxiliary pixel of the fourth color.

Examples of the colorant used in each of the red, green, and blue auxiliary pixels include a pigment and a dye. The red auxiliary pixel preferably contains PR-254; the green auxiliary pixel preferably contains PG-7, PG-36, or PG-58; and the blue auxiliary pixel preferably contains PB-15:6. Examples of the pigment used in the red auxiliary pixel, which is other than PR-254, include PR-149, PR-166, PR-177, PR-209, PY-138, PY-150, and PYP-139. Examples of the pigment used in the green auxiliary pixel, which is other than PG-7, PG-36, and PG-58, include PG-37, PB-16, PY-129, PY-138, PY-139, PY-150, and PY-185. Examples of the pigment used in the blue auxiliary pixel, which is other than PB-15:6, include PV-23.

Examples of the resin used in each of the red, green and blue auxiliary pixels include an acrylic resin, an epoxy resin, and a polyimide resin. A photosensitive acrylic resin is preferred since the resin can make production costs for the CF low.

The black matrix (hereinafter, “BM”) in the CF of the present invention is preferably a resin BM containing a light-shielding agent and a resin. Examples of the light-shielding agent include carbon black, titanium oxide, titanium oxynitride, titanium nitride, and iron tetraoxide.

The resin used in the resin BM is preferably a non-photosensitive polyimide resin since a fine pattern is easily formed. The non-photosensitive polyimide resin is preferably a polyimide resin obtained by subjecting a polyamic acid resin synthesized by an acid anhydride and a diamine to patterning, and then thermally curing the resin. Examples of the acid anhydride include pyromellitic dianhydride, 3,3′,4,4′-oxydiphthalcarboxylic dianhydride, 3,3′,4,4′-benzophenonetetracarboxylic dianhydride, and 3,3′,4,4′-biphenyltrifluoropropanetetracarboxylic dianhydride. Examples of the diamine include p-phenylenediamine, 3,3′-diaminodiphenyl ether, 4,4′-diaminodiphenyl ether, and 3,4′-diaminodiphenyl ether. Examples of a solvent for dissolving the polyamic acid resin include N-methyl-2-pyrrolidone and γ-butyrolactone.

It is preferred to form a transparent protective film on the CF in which the BM as well as the red, green and blue auxiliary pixels and the auxiliary pixel of the fourth color are formed. Examples of a resin used in the transparent protective film include an epoxy resin, an acrylic epoxy resin, an acrylic resin, a siloxane resin, and a polyimide resin.

The following will describe the respective shapes of the BM and the pixels which constitute the CF of embodiments of the present invention.

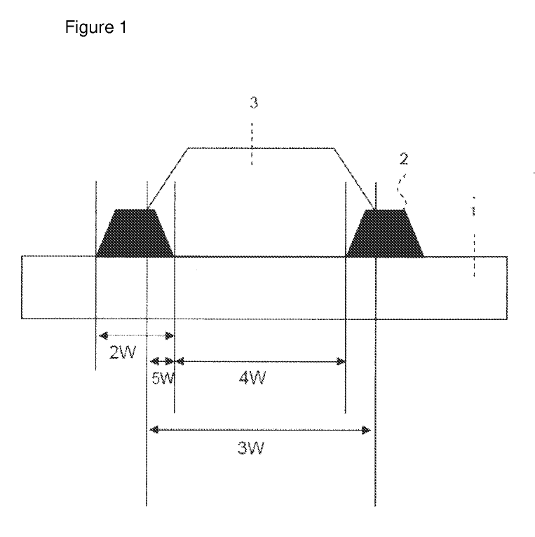

FIG. 1 is a schematic view illustrating a cross section of a black matrix formed on a transparent substrate, the section (rectangular in this example) being vertical to the longitudinal direction of an opening in the black matrix. In the sectional view, the broadest line width of the BM is represented by the BM line width 2W; the broadest width of an auxiliary pixel therein is represented by the auxiliary pixel width 3W; the narrowest width between two lines of the BM is represented by the opening width 4W; and the broadest width of an auxiliary pixel on one line of the BM is represented by the on-BM-line width 5W.

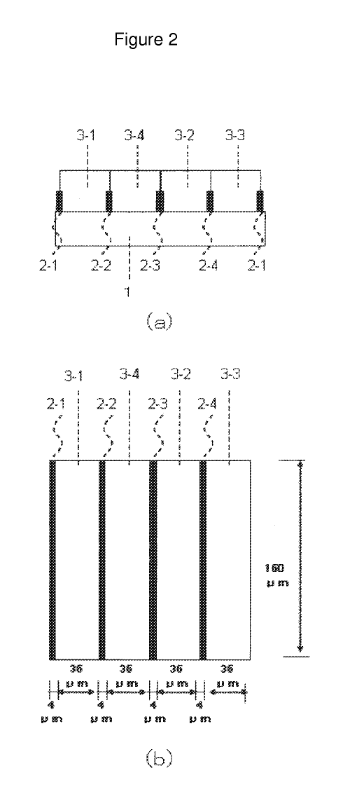

FIGS. 2(a) and 2(b) are, respectively, a sectional view and a plan view of a CF model according to a first embodiment of the present invention. As illustrated in the sectional view, lines (2-1) to (2-4) of the BM are formed on a transparent substrate (1). Each of a red auxiliary pixel (3-1), an auxiliary pixel 3-4 of a fourth color, a blue auxiliary pixel 3-2, and a green auxiliary pixel 3-3 is formed at an opening in the BM and on the BM. As also illustrated in the plan view, the BM is formed in a region 2-2 between the red auxiliary pixel and the auxiliary pixel of the fourth color, in a region 2-3 between the auxiliary pixel of the fourth color and the blue auxiliary pixel, in a region 2-4 between the blue and green auxiliary pixels, and in a region 2-1 between the green and red auxiliary pixels.

The BM line width 2W, the auxiliary pixel width 3W, the opening width 4W, and the on-BM-line width 5W in FIG. 1 may be varied among the respective auxiliary pixels, and among the respective BM lines in accordance with the variation in production. Thus, a scanning electron microscope (hereinafter, “SEM”) is used to observe auxiliary pixels selected at random and BM lines formed on both sides of each of the auxiliary pixels from above the upper surface of the CF, and each of the BM line width 2W, the auxiliary pixel width 3W, the opening width 4W, and the on-BM-line width 5W is determined. Such an operation is made as follows.

Using ten of each of the auxiliary pixels, a measurement of each of the values 2W to 5W is repeated 10 times. The respective averages are defined as the BM line width value (2W′), the auxiliary pixel width value (3W′), the opening width value (4W′), and the on-BM-line width value (5W′). In a more specific example, for ten of the auxiliary pixels of the fourth color, to be measured, which are selected at random from a CF, a scanning electron microscope is used to wholly observe the auxiliary pixels and BM lines formed on both sides of each of the auxiliary pixels. The respective BM line width 2W values determined are averaged, and the resultant average is defined as the BM line width (2W′) of the auxiliary pixels of the fourth color.

The value of “the line width L1 of the black matrix between the auxiliary pixel of the fourth color and each of other auxiliary pixels” corresponds to the value 2W′ of the auxiliary pixel of the fourth color. The value of “the broadest line width L2 of the black matrix” corresponds to the largest value out of the respective values 2W′ of the auxiliary pixels of red, green, blue, and the fourth color. The value of “the on-black-matrix-line width L3 of the auxiliary pixel of the fourth color” corresponds to the value 5W′ of the auxiliary pixel of the fourth color.

In the embodiment in FIG. 2, the values 2W′ are each 4.0 μm and the values 4W′ are each 36.0 μm.

The value L1 needs to be from 0 to 4.5 μm. If the value L1 is more than 4.5 μm, the aperture ratio of the auxiliary pixel of the fourth color is lowered. The value 2W′ of each of the red, green and blue auxiliary pixels is preferably from 3.5 to 5.5 μm. If the value 2W′ of each of the red, green and blue auxiliary pixels is more than 5.5 μm, the aperture ratio of each of the pixels is easily lowered. If the value 2W′ is less than 3.5 μm, white spots are easily generated in each of the red, green and blue auxiliary pixels. The value L3 is preferably from 0 to 2.0 μm. If the value L3 is more than 2.0 δm, the aperture ratio may be lowered.

In the CF model in FIG. 2, the value L1 ranges from 0 to 4.5 μm, and the value 2W′ of each of the red, green and blue auxiliary pixels ranges from 3.5 to 5.5 μm. Accordingly, no white spots are generated in the red, green and blue auxiliary pixels so that the aperture ratio of the pixel is high.

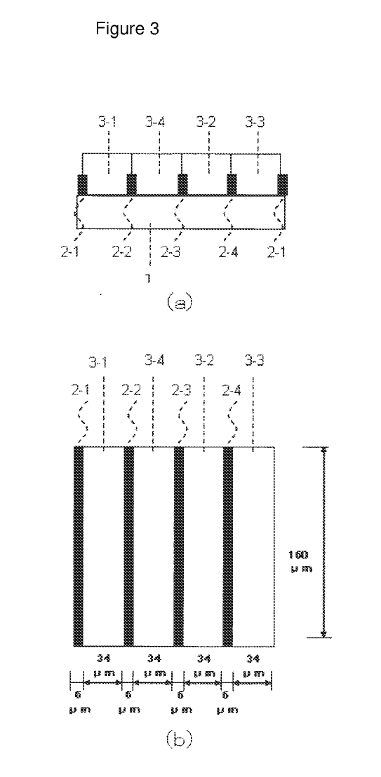

FIGS. 3(a) and 3(b) are, respectively, a cross section and a plan view of a CF model according to an embodiment which is not according to the present invention. The respective values 2W′ of auxiliary pixels, including the value L1, are each 6.0 μm, and the opening width of each of the auxiliary pixels is 34.0 μm, so that the CF is lowered in aperture ratio.

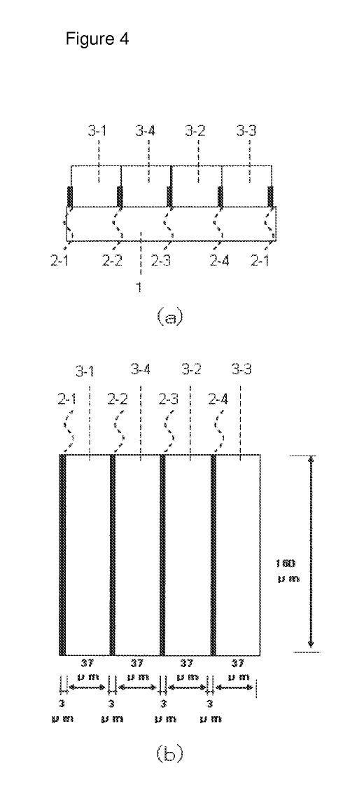

FIGS. 4(a) and 4(b) are, respectively, a cross section and a plan view of a CF model according to a second embodiment of the present invention. The respective values 2W′ of auxiliary pixels, including the value L1, are each 3.0 μm, so that the CF is high in aperture ratio.

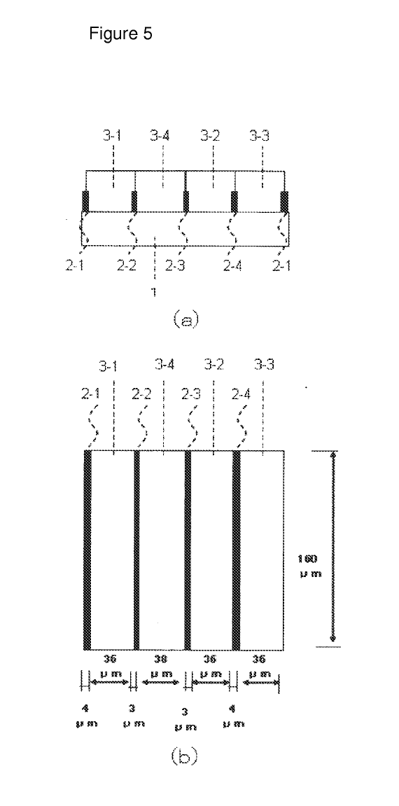

FIGS. 5(a) and 5(b) are, respectively, a cross section and a plan view of a CF model according to a third embodiment of the present invention. The value L1 is 3.0 μm, and the respective values 2W′ of red, green and blue auxiliary pixels are each 4.0 μm, so that no white spots are generated in the red, green and blue auxiliary pixels and an auxiliary pixel of a fourth color is high in aperture ratio.

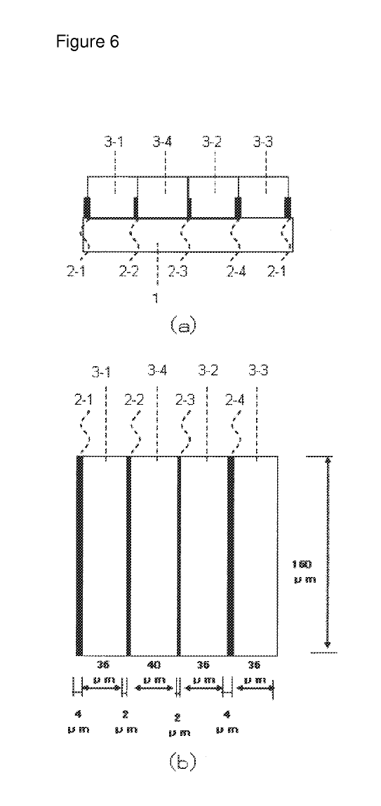

FIGS. 6(a) and 6(b) are, respectively, a cross section and a plan view of a CF model according to a fourth embodiment of the present invention. The value L1 is 2.0 μm, and the respective values 2W′ of red, green and blue auxiliary pixels are each 4.0 μm, so that no white spots are generated in the red, green and blue auxiliary pixels and an auxiliary pixel of a fourth color is very high in aperture ratio.

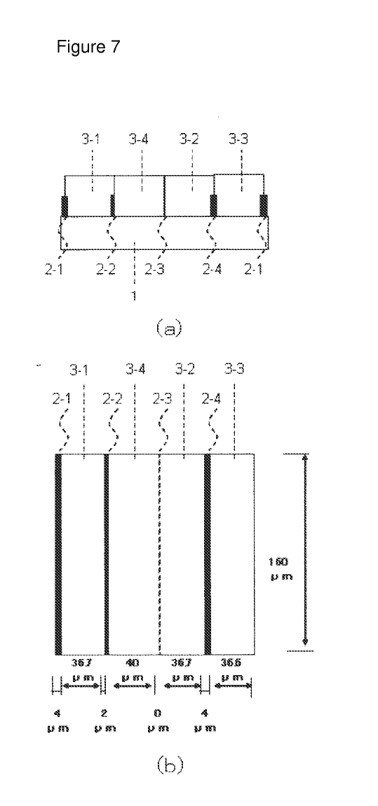

FIGS. 7(a) and 7(b) are, respectively, a cross section and a plan view of a CF model according to a fifth embodiment of the present invention. The value L1 is 0.0 μm. Furthermore, no BM line is present between an auxiliary pixel of a fourth color and a blue auxiliary pixel, and the respective values 2W′ of red, green and blue auxiliary pixels are each 4.0 μm. Thus, the aperture ratio is very high. Since the auxiliary pixel of the fourth color is adjacent to the blue auxiliary pixel, no white spots are generated although no BM line is present between these auxiliary pixels.

In the CF model in FIG. 7, the hue of the auxiliary pixel of the fourth color is preferably light blue or light violet. This is because the hue system of the auxiliary pixel of the fourth color is made equal to that of the blue auxiliary pixel, thereby causing no problem of color shift due to color mixing even when no BM line is present between the auxiliary pixel of the fourth color and the blue auxiliary pixel.

The line width of the black matrix between the auxiliary pixel of the fourth color and each of the other auxiliary pixels is represented by L1. The line width of the black matrix between the auxiliary pixel of the fourth color and the red auxiliary pixel is represented by L1R; that of the black matrix between the auxiliary pixel of the fourth color and the green auxiliary pixel is represented by L1G; and that of the black matrix between the auxiliary pixel of the fourth color and the blue auxiliary pixel is represented by L1B. The value L1B is preferably from 0 to 3.5 μm, more preferably from 0 to 2.5 μm. The value L1B is even more preferably 0 μm, namely, no BM line is present therebetween; in this case, the pixel is very high in aperture ratio.

The relationship between the values L1 and L2 preferably satisfies: 0≦L1/L2≦0.8. By setting the ratio of L1/L2 in this range, while white spots are prevented in the red, green and blue pixels, the aperture ratio of the pixel can be made maximum. In the CF model in FIG. 2, the ratio of L1/L2 is 1; in that in FIG. 5, the ratio of L1/L2 is 0.75; in that in FIG. 6, the ratio of L1/L2 is 0.5; and in that in FIG. 7, the ratio of L1/L2 is 0.

It is considered that the state of any adjacent two of the auxiliary pixels is anyone of a state that the two auxiliary pixels never contact each other, a state that one of the two auxiliary pixels rides on the other auxiliary pixel so that the two contact each other, and a state that one of the two auxiliary pixels contacts the other auxiliary pixel without riding on the other. In the state that one of the auxiliary pixels rides on the other auxiliary pixel, a difference in level of the surface of the CF is unfavorably made large by the resultant projections. However, even in such a state, the flatness of the CF can be adjusted in a permissible range, that is, the level difference can be decreased to 0.5 μm or less by forming a flat film thereon afterward, if the level difference of the projections is 1.0 μm or less.

In the present invention, the value L3 is preferably from 0 to 2.0 μm, more preferably from 0 to 1.0 μm. If the value L3 is more than 2.0 μm, the CF is lowered in aperture ratio. The value 5W′ of each of the red, green and blue auxiliary pixels is preferably from 1.5 to 2.5 μm. If the value 5W′ of each of the red, green and blue auxiliary pixels is less than 1.5 μm, white spots are easily generated. If the value 5W′ is more than 2.5 μm, the CF is easily lowered in aperture ratio.

Examples of the shape of the pixel including the red, green and blue auxiliary pixels and the auxiliary pixel of the fourth color include stripe, mosaic, and triangular shapes. The width of each of the auxiliary pixels is preferably from 10 to 100 μm, more preferably from 20 to 50 μm. If the width of the auxiliary pixel is more than 100 μm, the CF is lowered in resolution so that the resultant liquid crystal display device is deteriorated in display performance. If the pixel width is less than 10 μm, the CF is lowered in aperture ratio.

In the red, green and blue auxiliary pixels and the auxiliary pixel of the fourth color in the present invention, the area of an opening in each of the auxiliary pixels is preferably from 240 to 3120 μm². When the area of the opening in each of the auxiliary pixels in the CF is set in this range, a high resolution and a rise in the brightness of the CF and the liquid crystal display device can be satisfied at the same time.

A unit dot is obtained from the BM and each of the auxiliary pixels. The total of the area of the BM and the area of the opening in each of the auxiliary pixels is the area of the unit dot. The shape of the unit dot is preferably square or rectangular. The area of the unit dot is preferably from 1500 to 17000 μm². If the area of the unit dot is larger than 17000 μm², the CF is low in resolution so that the liquid crystal display device is deteriorated in display performance. If the area is less than 1500 μm², it is feared that the CF is lowered in aperture ratio. In the CF model in FIG. 2, the unit dot shape is square, and the width and the length thereof are each 160 μm. Thus, the area of the unit dot is 25600 μm².

The following will describe an example of a method for producing the CF of the present invention.

Examples of the transparent substrate include sodium glass, non-alkaline glass, and quartz glass.

Preferably, a light-shielding agent composition is used on the transparent substrate to form a resin BM, and then a colorant composition is used to form each of auxiliary pixels of red, green, blue and a fourth color.

The light-shielding agent composition is prepared by mixing a polyamic acid resin and a solvent with a light-shielding agent, subjecting the mixture to dispersing treatment, and then adding various additives thereto. In this case, the entire solid content therein is the total of the polyamide acid resin, which is a resin component, and the light-shielding agent.

Next, the light-shielding agent composition is applied by a method using, for example, a spin coater or a die coater, then vacuum-dried and semi-cured at 90 to 130° C. to form a coating film of the light-shielding agent. A positive resist is applied thereon, and then vacuum-dried to form a resist film. Thereafter, for example, a super-high-pressure mercury lamp, a chemical lamp or a high-pressure mercury lamp is used to selectively expose the resist film to ultraviolet rays or the like through a positive mask, and then an exposed portion is removed with an alkaline developing solution of, for example, potassium hydroxide or tetramethylammonium hydroxide to yield a pattern. A stripping solution is used to strip the positive resist, then the resultant is heated at 270 to 300° C. to advance the imidization of the polyamic, acid resin, and a resin BM is yielded. By varying the pattern shape of the positive mask, and the semi-curing temperature, the line width of the resin BM can be changed.

The colorant composition is produced using a colorant and a resin. When a pigment is used as the colorant, a polymer dispersing agent and a solvent are mixed with the pigment, and the mixture is subjected to dispersing treatment. Thereafter, thereto are added an alkali-soluble resin, a monomer, photopolymerization initiator, and the like to produce the composition. When a dye is used as the colorant, to the dye are added a solvent, an alkali-soluble resin, a monomer, photopolymerization initiator, and the like to produce the composition. In this case, the entire solid content therein is the total of the polymer dispersing agent and the alkali-soluble resin, which are resin components, the monomer, and the colorant.

The resultant colorant composition is applied onto the transparent substrate, on which the resin BM is formed, by a method using, for example, a spin coater or a die coater, and then vacuum-dried to form a coating film of the colorant. Next, a negative mask is disposed thereon, and then, for example, a super-high-pressure mercury lamp, a chemical lamp or a high-pressure mercury lamp is used to selectively expose the coating film to ultraviolet rays or the like. Thereafter, the resultant is developed with an alkaline developing solution to remove the unexposed portion, thereby providing a pattern. The resultant coating film pattern is subjected to heating treatment to produce a CF in which auxiliary pixels are patterned. By using the colorant composition produced for each of the auxiliary pixels, the patterning step as described above is performed successively for the red auxiliary pixel, the green auxiliary pixel, the blue auxiliary pixel, and the auxiliary pixel of the fourth color, thereby producing the pixel of the CF according to an embodiment of the present invention. The order of patterning of the auxiliary pixels is not particularly limited.

The type of the CF of the present invention may be any of transmissive, reflective and transflective types. The type is preferably the transmissive type since the CF of this type is low in production costs and high in contrast ratio.

The following will describe methods for evaluating the CF of the present invention.

About the chromaticity of each of the auxiliary pixels of red, green, blue and the fourth color, a microscopic spectrophotometer (for example, MCPD-2000, manufactured by Otsuka Electronics Co., Ltd.) is used to measure the transmittance spectrum of each of the auxiliary pixels, and then the tristimulus value (Y) and the chromaticity (x, y) are calculated on the basis of the CIE 1931 standard.

The white balance of the CF can be evaluated from the absolute value (|Δx|, |Δy|) of the difference (Δx, Δy) between the chromaticity (x, y) of the auxiliary pixel of the fourth color and the chromaticity (x, y) of an additively mixed color of the red, green and blue auxiliary pixels. The |Δx| and |Δy| are preferably smaller because the CF is better in white balance.

The transmittance of pixels of the CF can be evaluated from the value (Y) of the auxiliary pixel of the fourth color and the value (Y) of the additively mixed color of the red, green and blue auxiliary pixels, the values (Y) being obtained as described above.

The color reproduction range of the CF can be obtained by calculating the area of a triangle obtained by connecting the respective chromaticities (x, y) of the red, green and blue auxiliary pixels to one another, the area of a triangle obtained by connecting the NTSC standard chromaticities (x, y) to one another, and then calculating the ratio between the areas. The NTSC standard chromaticities (x, y) are red (0.67, 0.33), green (0.21, 0.71), and blue (0.14, 0.08). The color reproduction range of the CF is preferably from 70 to 100%. In the CF of the present invention, the value (Y) of each of the red, green and blue auxiliary pixels is typically lower as the color reproduction range is broader. However, the value (Y) of the auxiliary pixel of the fourth color is a high value notwithstanding the color reproduction range. Accordingly, in the CF of the present invention, the value (Y) of the CF can be made high even in the color reproduction range of 70 to 100%, which is considered to be a sufficiently broad range.

The respective lengths of lines of the BM, and the pixels are measureable by, for example, observation through an optical microscope.

The aperture ratio of each of the auxiliary pixels can be calculated from the ratio between the area of the whole of the unit dot, and that of the opening in each of the auxiliary pixels. More specifically, the aperture ratio can be calculated in accordance with the following expression (3):

Aperture ratio (%) of each of auxiliary pixels=(area of opening in auxiliary pixel)/(area of BM+area of openings in all auxiliary pixels)×100 expression (3)

wherein the area of the opening in each of the auxiliary pixels means the product of the value 4W′ of the auxiliary pixel and the length of the pixel, and the area of the BM means the product of the value 2W′ of the BM and the length of the BM.

The total transmittance of the CF can be calculated from the respective products of the respective transmittances of the auxiliary pixels and the respective aperture ratios of the auxiliary pixels. More specifically, they can be calculated in accordance with the following expressions 4 to 6:

Total transmittance (%) of CF=(total transmittance of red, green and blue auxiliary pixels)+(total transmittance of auxiliary pixel of fourth color) expression 4

Total transmittance (%) of red, green and blue auxiliary pixels=(transmittance of additively mixed color of red, green and blue auxiliary pixels)×(aperture ratio of red, green and blue auxiliary pixels)/100 expression 5

Total transmittance (%) of auxiliary pixel of fourth color=(transmittance of auxiliary pixel of fourth color)×(aperture ratio of auxiliary pixel of fourth color)/100 expression 6

In the CF of embodiments of the present invention, the value (Y) of the auxiliary pixel of the fourth color is as high as in the range of 70≦Y≦99. Therefore, by improving the aperture ratio of the auxiliary pixel of the fourth color, the total transmittance of the CF can be largely improved. The aperture ratio of the auxiliary pixel of the fourth color is preferably from 22 to 26%. If the aperture ratio of the auxiliary pixel of the fourth color is less than 22%, the total transmittance of the CF is easily lowered. If the aperture ratio of the auxiliary pixel of the fourth color is more than 26%, the color purity of the CF may be lowered.

White spots in the CF can be evaluated by observation through an optical microscope. It is preferred that no white spots are generated at any interface between the red, green and blue auxiliary pixels and the BM.

The film thickness of the BM and that of each of the auxiliary pixels can be measured with a surface profiler (for example, SURFCOM 1400D, manufactured by Tokyo Seimitsu Co., Ltd.). When a transparent protective film layer, an ITO layer, or the like is formed on the BM and each of the auxiliary pixels in the CF, the film thickness of the BM and that of each of the auxiliary pixels can be measured by SEM observation.

The film thickness of each of the red, green and blue auxiliary pixels is preferably from 1.5 to 2.5 μm. If the film thickness is smaller than 1.5 μM, the red, green and blue auxiliary pixels may be poor in chromaticity. If the film thickness is more than 2.5 μm, the CF may be lowered in flatness.

The film thickness of the auxiliary pixel of the fourth color is preferably from 0.8 to 2.0 μm. If the film thickness is more than 2.0 μm, the CF is easily lowered in transmittance by the yellowing of the resin in the pixel of the fourth color. If the film thickness is less than 0.8 μm, the pixel of the fourth color is easily poor in patterning ability.

The film thickness of the BM is preferably from 0.5 to 1.5 μm. If the film thickness is less than 0.5 μm, white spots may be generated in the red, green and blue auxiliary pixels. If the film thickness is more than 1.5 μm, the CF may be lowered in flatness.

The following will describe an example of a liquid crystal display device having the CF of an embodiment of the present invention. The CF and an array substrate are opposed and bonded to each other to interpose, therebetween, a liquid crystal alignment film laid on each of the substrate of the CF and the array substrate and further subjected to rubbing treatment for liquid crystal alignment, and a spacer for holding a cell gap. On the array substrate are arranged thin film transistors (hereinafter, “TFTs”), thin film diodes (hereinafter, “TFDs”), scanning lines or signal lines, and others, so that a TFT liquid crystal display device or TFD liquid crystal display device can be produced. Next, a liquid crystal is injected into the device through an injection hole provided in its sealing region to seal the injection hole. Finally, a backlight is fitted to the device, and then an IC driver and others are mounted thereon, so that the liquid crystal display device is completed. Examples of the backlight include two-wavelength LED backlights, three-wavelength LED backlights, and CCFLs. It is preferred to use a two-wavelength LED composed of a blue LED and a yellow YAG phosphor. The chromaticity (x, y) of the backlight is preferably in the range of 0.250≦x≦0.35 and 0.300≦y≦0.400. A liquid crystal display device having a backlight having a chromaticity (x, y) in this range and the CF of the present invention is good in white display chromaticity (x, y), and is small in unevenness of the white display chromaticity (x, y) in its display screen to be excellent in white balance.

### EXAMPLES

Hereinafter, the present invention will be described in more detail by way of Examples and Comparative Examples. Standards for evaluating each CF are as follows.

### (White Balance of CF)

Rating of being excellent: 0≦|Δx|≦005 and 0≦|Δy|0.005.

Rating of being good: a larger value of the values |Δx| and |Δy| was in the range of 0.05<(|Δx| or |Δy|)≦0.010.

Rating of being allowable: a larger value of the values |Δx| and |Δy| was in the range of 0.010<(|Δx| or |Δy|)≦0.020.

Rating of being poor: a larger value of the values |Δx| and |y| was in the range of 0.020<(|Δx| or |Δy|).

### (White Spots in Red, Green and Blue Auxiliary Pixels)

Five CFs were produced which each had 100 unit dots each having a size of 160 μm in width×160 μm in length and each having BM lines and auxiliary pixels of red, green, blue and a fourth color. The CFs were observed through an optical microscope. In this case,

no white spot was present at all in the red, green and blue pixels: good, and

at least one white spot was present in the red, green and blue pixels: poor.

### (Patterning Ability of Auxiliary Pixel of Fourth Color)

Five CFs were produced which each had 100 unit dots each having a size of 160 μm in width×160 μm in length and having BM lines and auxiliary pixels of red, green, blue and a fourth color. The CFs were observed through an optical microscope. In this case,

no chip was present at all in a pattern region of the auxiliary pixel of the fourth color: good, and

less than five chips were present in the pattern region of the auxiliary pixel of the fourth color: allowable.

### Adjustment Example 1

### Production of Red Colorant Composition for Forming Red Auxiliary Pixel

As colorants, 50 g of PR-177 (CHROMOFINE (registered trade mark) Red 6125EC, manufactured by Dainichiseika Color & Chemicals Mfg. Co., Ltd.) and 50 g of PR-254 (IRGAPHOR (registered trade mark) Red BK-CF, manufactured by Ciba Specialty Chemicals Ltd.) were mixed with each other. With this mixed colorant were mixed 100 g of a polymer dispersing agent (BYK 2000, manufactured by BYK-Chemie Japan KK; resin concentration: 40% by mass), 67 g of an alkali-soluble resin (CYCLOMER (registered trade mark) ACA 250, manufactured by Daicel Corp.; resin concentration: 45% by mass), 83 g of propylene glycol monomethyl ether, and 650 g of propylene glycol monomethyl ether acetate to prepare a slurry. A baker in which the slurry was placed was connected through a tube to a circulation type bead mill disperser (Dyno-Mill KDL-A, manufactured by Willy A. Bachofen AG). Zirconia beads having a diameter of 0.3 mm were used as media to subject the slurry to dispersing treatment at 3200 rpm for 4 hours, to yield a colorant dispersion.

To 45.7 g of this colorant dispersion were added 7.8 g of the CYCLOMER ACA 250, 3.3 g of a photopolymerizable monomer (KAYARAD (registered trade mark) DPHA, manufactured by Nippon Kayaku Co., Ltd.), 0.2 g of a photopolymerization initiator (IRGACURE (registered trade mark) 907, manufactured by Ciba Specialty Chemicals Ltd.), 0.1 g of a photopolymerization initiator (KAYACURE (registered trade mark) DETX-S, manufactured by Nippon Kayaku Co., Ltd.), 0.03 g of a surfactant (BYK 333, manufactured by BYK-Chemie Japan KK), and 42.9 g of propylene glycol monomethyl ether acetate to yield a colorant composition. The colorant concentration in the entire solid in the colorant composition was 31% by mass, and the mixing ratio by mass between the respective colorants was as follows: PR-177/PR-254=50/50.

### Adjustment Example 2

### Production of Green Colorant Composition for Forming Green Auxiliary Pixel

As colorants, 65 g of PG-7 (HOSTAPERM (registered trade mark) Green GNX, manufactured by Clariant Japan K.K.) and 35 g of PY-150 (E4GNGT, manufactured by Lanxess) were mixed with each other. With this mixed colorant were mixed 100 g of the BYK 2000, 67 g of the CYCLOMER ACA 250, 83 g of propylene glycol monomethyl ether, and 650 g of propylene glycol monomethyl ether acetate. The Dyno-Mill KDL-A was used to subject the resultant slurry to dispersing treatment at 3200 rpm for 6 hours, using zirconia beads having a diameter of 0.3 mm, to yield a colorant dispersion.

To 51.7 g of this colorant dispersion were added 6.3 g of the CYCLOMER ACA 250, 2.9 g of the KAYARAD DPHA, 0.2 g of the IRGACURE 907, 0.1 g of the KAYACURE DETX-S, 0.03 g of the BYK 333, and 38.8 g of propylene glycol monomethyl ether acetate to yield a colorant composition. The colorant concentration in the entire solid in the colorant composition was 35% by mass, and the mixing ratio was as follows: PG-7:PY-150=65:35.

### Adjustment Example 3

### Production of Blue Colorant Composition for Forming Blue Auxiliary Pixel

As a colorant, 100 g of PB-15:6 (LIONOL (registered trade mark) Blue 7602, manufactured by Toyo Ink Co., Ltd.) was used. With this colorant were mixed 100 g of the BYK 2000, 67 g of the CYCLOMER ACA 250, 83 g of propylene glycol monomethyl ether, and 650 g of propylene glycol monomethyl ether acetate to prepare a slurry. The disperser Dyno-Mill KDL-A was used to subject the slurry to dispersing treatment at 3200 rpm for 3 hours, using zirconia beads having a diameter of 0.3 mm, to yield a colorant dispersion.

To 41.3 g of this colorant dispersion were added 8.9 g of the CYCLOMER ACA 250, 3.5 g of the KAYARAD DPHA, 0.2 g of the IRGACURE 907, 0.1 g of the KAYACURE DETX-S, 0.03 g of the BYK 333, and 46 g of propylene glycol monomethyl ether acetate to yield a colorant composition. The colorant concentration in the entire solid in the colorant composition was 28% by mass, and the colorant was PB-15:6 alone.

### Adjustment Example 4

### Production of Light-Color Colorant Composition for Forming Auxiliary Pixel of Fourth Color

To 1.00 g of the colorant dispersion yielded in Adjustment Example 3 were added 8.30 g of the CYCLOMER ACA 250 (alkali-soluble resin), 5.65 g of the KAYARAD DPHA (photopolymerizable monomer A), 0.20 g of the IRGACURE 907, 0.10 g of the KAYACURE DETX-S, 0.03 g of the BYK 333, and 84.72 g of propylene glycol monomethyl ether acetate to yield a colorant composition. The colorant concentration in the entire solid in the colorant composition was 1% by mass, and the colorant was PB-15:6 alone.

### Adjustment Example 5

### Production of Composition for Forming Auxiliary Pixel of Fourth Color

The followings were mixed with one another to yield a colorant composition: 8.30 g of the CYCLOMER ACA 250, 5.65 g of the KAYARAD DPHA, 0.20 g of the IRGACURE 907, 0.1 g of the KAYACURE DETX-S, 0.03 g of the BYK 333, and 84.72 g of propylene glycol monomethyl ether acetate. This composition did not contain any colorant.

### Adjustment Example 6

### Production of Light-Color Colorant Composition for Forming Auxiliary Pixel of Fourth Color)

To 0.50 g of the colorant dispersion yielded in Adjustment Example 3 were added 8.40 g of the CYCLOMER ACA 250, 5.69 g of the KAYARAD DPHA, 0.2 g of the IRGACURE 907, 0.10 g of the KAYACURE DETX-S, 0.03 g of the BYK 333, and 85.08 g of propylene glycol monomethyl ether acetate to yield a colorant composition. The colorant concentration in the entire solid in the colorant composition was 0.5% by mass, and the colorant was PB-15:6 alone.

### Adjustment Example 7

### Production of Light-Color Colorant Composition for Forming Auxiliary Pixel of Fourth Color

To 1.98 g of the colorant dispersion yielded in Adjustment Example 3 were added 8.12 g of the CYCLOMER ACA 250, 5.57 g of the KAYARAD DPHA, 0.2 g of the IRGACURE 907, 0.1 g of the KAYACURE DETX-S, 0.03 g of the BYK 333, and 84.00 g of propylene glycol monomethyl ether acetate to yield a colorant composition. The colorant concentration in the entire solid in the colorant composition was 2% by mass, and the colorant was PB-15:6 alone.

### Adjustment Example 8

### Production of Light-Color Colorant Composition for Forming Auxiliary Pixel of Fourth Color

To 3.96 g of the colorant dispersion yielded in Adjustment Example 10 were added 7.74 g of the CYCLOMER ACA 250, 5.40 g of the KAYARAD DPHA, 0.2 g of the IRGACURE 907, 0.1 g of the KAYACURE DETX-S, 0.03 g of the BYK 333, and 82.57 g of propylene glycol monomethyl ether acetate to yield a colorant composition. The colorant concentration in the entire solid in the colorant composition was 4% by mass, and the colorant was PB-15:6 alone.

### Adjustment Example 9

### Production of Black Light-Shielding Agent Composition for Forming BM

Into a vessel were charged 4,4′-diaminophenyl ether (0.30 molar equivalent), p-phenylenediamine (0.65 molar equivalent) and bis(3-aminopropyl)tetramethyldisiloxane (0.05 molar equivalent) together with 850 g of γ-butyrolactone and 850 g of N-methyl-2-pyrrolidone. Thereto was added 3,3′,4,4′-oxydiphthalcarboxylic dianhydride (0.9975 molar equivalent), and then the reactive components therein were allowed to react with one another at 80° C. for 3 hours. Thereto was added maleic anhydride (0.02 molar equivalent) to further conduct the reaction at 80° C. for 1 hour, to yield a polyamic acid resin solution (resin concentration: 20% by mass).

With 250 g of this polyamic acid resin solution were mixed 50 g of carbon black (MA 100, manufactured by Mitsubishi Chemical Corp.) and 200 g of N-methylpyrrolidone. The Dyno-Mill KDL-A was used to subject the mixture to dispersing treatment at 3200 rpm for 3 hours, using zirconia beads having a diameter of 0.3 mm, to yield a light-shielding agent dispersion.

To 50 g of this light-shielding agent dispersion were added 49.9 g of N-methylpyrrolidone and 0.1 g of a surfactant (LC 951, manufactured by Kusumoto Chemicals, Ltd.) to yield a non-photosensitive light-shielding agent composition. The concentration of the colorant in the entire solid in the light-shielding agent composition was 50%, and the colorant was carbon black alone.

### Adjustment Example 10

### Production of Resin Composition for Forming Transparent Protective Film

To 65.05 g of trimellitic acid were added 280 g of γ-butyrolactone and 74.95 g of γ-aminopropyltriethoxysilane, and the mixture was heated at 120° C. for 2 hours. To 20 g of the resultant solution were added 7 g of bisphenoxyethanol fluorene diglycidyl ether and 15 g of diethylene glycol dimethyl ether to yield a resin composition.

### Adjustment Example 11

### Production of Light-Color Colorant Composition for Forming Auxiliary Pixel of Fourth Color

The same materials as in Adjustment Example 1 were used to produce a colorant composition. The concentration of the colorant in the entire solid was set to 1.1% by mass, and the colorant was PB-15:6 alone.

### Adjustment Example 12

### Production of Light-Color Colorant Composition for Forming Auxiliary Pixel of Fourth Color

The same materials as in Adjustment Example 1 were used to produce a colorant composition. The concentration of the colorant in the entire solid was set to 2.5% by mass, and the colorant was PB-15:6 alone.

### Adjustment Example 13

### Production of Light-Color Colorant Composition for Forming Auxiliary Pixel of Fourth Color

The same materials as in Adjustment Example 1 were used to produce a colorant composition. The concentration of the colorant in the entire solid was set to 2.9% by mass, and the colorant was PB-15:6 alone.

### Adjustment Example 14

### Production of Light-Color Colorant Composition for Forming Auxiliary Pixel of Fourth Color

The same materials as in Adjustment Example 1 were used to produce a colorant composition. The concentration of the colorant in the entire solid was set to 0.9% by mass, and the colorant was PB-15:6 alone.

### Example 1

### Production of CF Having BM and Auxiliary Pixels of Red, Green, Blue and Fourth Color

The light-shielding agent composition yielded in Adjustment Example 9 was applied onto a non-alkali glass substrate (OA-10, manufactured by Nippon Electric Glass Co., Ltd.) having a size of 300×350 mm using a spinner, and thereafter subjected to heating treatment at 135° C. in a hot air oven for 20 minutes to yield a light-shielding film. Subsequently, a positive resist (MICROPOSIT (registered trade mark) RC100, manufactured by Shipley; 30 cp) was applied thereon using a spinner, and then dried at 90° C. for 10 minutes. The film thickness of the positive resist was set to 1.5. An exposing device, PLA-501F (manufactured by Canon Inc.), was used to expose the resultant through a positive mask. About the positive mask, the width of its unexposed portion (BM portion) was set to 4.0 μm, and that of its exposed portion (auxiliary pixel portion) was set to 36.0 μm. The gap between the lower surface of the photo mask and the upper surface of the glass substrate was adjusted to 100 μm. Next, an aqueous solution containing 2% by mass of tetramethylammonium hydroxide at 23° C. was used as a developing solution. The substrate was dipped into the developing solution and simultaneously the substrate was swung to reciprocate in a range of 10 cm width one time every five seconds. In this way, the development of the positive resist and the etching of the polyimide precursor were simultaneously performed. Thereafter, the positive resist was striped with methylcellosolve acetate. The resultant was then held in the hot air oven at 290° C. for 30 minutes to cure the polyimide acid resin, and a resin BM was yielded. The rotation number of the spinner was adjusted so that the film thickness of the resin BM was 0.8 μm.

The red colorant composition yielded in Adjustment Example 1 was applied onto the glass substrate, on which the resin BM was formed, using a spinner, and then subjected to heating treatment at 90° C. in the hot air oven for 10 minutes to yield a red colored film. Next, the exposing device PLA-501F was used to expose the film through a negative mask. About the negative mask, the width of its exposed portion (red auxiliary pixel portion) was set to 36 μm. Thereafter, while swung, the resultant was immersed in an alkaline developing solution, in which a nonionic surfactant (EMULGEN (registered trade mark) A-60, manufactured by Kao Corp.) was added in a proportion of 0.1% by mass of the total of the developing solution, for 90 seconds. Subsequently, the resultant was washed with pure water to remove the unexposed portion. Thus, a patterned substrate was yielded. Thereafter, the patterned substrate was held in the hot air oven at 220° C. for 30 minutes to cure the acrylic resin. In this way, a red auxiliary pixel was yielded.

The green colorant composition yielded in Adjustment Example 2 was used to form a green auxiliary pixel in the same way as in the case of the red auxiliary pixel. The blue colorant composition yielded in Adjustment Example 3 was used to form a blue auxiliary pixel in the same way as in the case of the red auxiliary pixel. The light-color colorant composition yielded in Adjustment Example 4 was used to form a auxiliary pixel in the fourth color. The rotation number of the spinner for the composition in each of red, green blue and the fourth color was adjusted so that the film thickness of the auxiliary pixel of each of these colors was 2.0 μm after curing.

Next, the resin composition yielded in Adjustment Example 10 was applied using a spinner, and then pre-baked at 130° C. in the hot air oven for 5 minutes. Next, the resultant was subjected to heating treatment at 210° C. in the hot air oven for 30 minutes to cure the resin. The rotation number of the spinner for each of the compositions was adjusted so that the film thickness of the transparent protective film after curing was 1.5 μm.

### Examples 2 and 3, and Comparative Examples 1 and 2

A CF of each of Examples 2 and 3 and Comparative Examples 1 and 2 was produced in the same way as in Example 1 except that the light-color colorant composition for the auxiliary pixel of the fourth color was changed. Table 1 shows the respective compositions used to form the BM and each of the auxiliary pixels.

TABLE 1

| | | | | Auxiliary pixel of | | | |
|---|---|---|---|---|---|---|---|
| | | | | fourth color | | | |
| | Composition for | Composition for | Composition for | | | Colorant | |
| | red auxiliary | green auxiliary | blue auxiliary | | | concentration (% | Composition |
| | pixel | pixel | pixel | Composition | Colorant | by weight) | for BM |
| Example 1 | Adjustment | Adjustment | Adjustment | Adjustment | PB15:6 | 1 | Adjustment |
| | Example 1 | Example 2 | Example 3 | Example 4 | | | Example 9 |
| Comparative | Adjustment | Adjustment | Adjustment | Adjustment | None | 0 | Adjustment |
| Example 1 | Example 1 | Example 2 | Example 3 | Example 5 | | | Example 9 |
| Example 2 | Adjustment | Adjustment | Adjustment | Adjustment | PB15:6 | 0.5 | Adjustment |
| | Example 1 | Example 2 | Example 3 | Example 6 | | | Example 9 |
| Example 3 | Adjustment | Adjustment | Adjustment | Adjustment | PB15:6 | 2 | Adjustment |
| | Example 1 | Example 2 | Example 3 | Example 7 | | | Example 9 |
| Comparative | Adjustment | Adjustment | Adjustment | Adjustment | PB15:6 | 4 | Adjustment |
| Example 2 | Example 1 | Example 2 | Example 3 | Example 8 | | | Example 9 |

Table 2 shows evaluation results of the respective tristimulus values (Y) and chromaticities (x, y) of the auxiliary pixels of red, green, blue and the fourth color.

TABLE 2

| | | | | | | | | | | Additive color | | | | | |
|---|---|---|---|---|---|---|---|---|---|---|---|---|---|---|---|
| | Red auxiliary | | | Green auxiliary | | | Blue auxiliary | | | mixture of red, | | | Auxiliary pixel of | | |
| | pixel | | | pixel | | | pixel | | | green and blue | | | fourth color | | |
| | x | Y | Y | x | y | Y | x | y | Y | x | y | Y | x | y | Y |
| Example 1 | 0.630 | 0.311 | 19.6 | 0.223 | 0.601 | 43.6 | 0.134 | 0.120 | 14.7 | 0.280 | 0.302 | 25.9 | 0.285 | 0.303 | 88.2 |
| Comparative | 0.630 | 0.311 | 19.6 | 0.223 | 0.601 | 43.6 | 0.134 | 0.120 | 14.7 | 0.280 | 0.302 | 25.9 | 0.310 | 0.317 | 99.4 |
| Example 1 | | | | | | | | | | | | | | | |
| Example 2 | 0.630 | 0.311 | 19.6 | 0.223 | 0.601 | 43.6 | 0.134 | 0.120 | 14.7 | 0.280 | 0.302 | 25.9 | 0.289 | 0.309 | 91.2 |
| Example 3 | 0.630 | 0.311 | 19.6 | 0.223 | 0.601 | 43.6 | 0.134 | 0.120 | 14.7 | 0.280 | 0.302 | 25.9 | 0.271 | 0.293 | 73.3 |
| Comparative | 0.630 | 0.311 | 19.6 | 0.223 | 0.601 | 43.6 | 0.134 | 0.120 | 14.7 | 0.280 | 0.302 | 25.9 | 0.248 | 0.284 | 65.3 |
| Example 2 | | | | | | | | | | | | | | | |

Table 3 shows evaluation results of the respective white balances and transmittances of the CFs.

TABLE 3

| | | | | Auxiliary pixel | | |
|---|---|---|---|---|---|---|
| | | | | transmittance (%) | | |
| | | | | Additive | | |
| | | | | color | | |
| | | | | mixture of | | Color re- |
| | White balance | | | red, green | Fourth | production |
| | \|Δx\| | \|Δy\| | Rating | and blue | color | range (%) |
| Example 1 | 0.005 | 0.001 | Excellent | 25.9 | 88.2 | 70 |
| Comparative | 0.030 | 0.015 | Poor | 25.9 | 99.4 | 70 |
| Example 1 | | | | | | |
| Example 2 | 0.009 | 0.007 | Good | 25.9 | 91.2 | 70 |
| Example 3 | 0.009 | 0.009 | Good | 25.9 | 73.3 | 70 |
| Comparative | 0.032 | 0.018 | Poor | 25.9 | 65.3 | 70 |
| Example 2 | | | | | | |

As shown in Tables 1 to 3, in each of the CFs of Examples 1 to 3, the concentration of the colorant in the auxiliary pixel of the fourth color was from 0.3 to 3% by mass and further the value (Y) of the auxiliary pixel of the fourth color was from 70 to 99, and thus each of the CFs was good in white balance and high in transmittance. In particular, in the CF of Example 1, the concentration of the colorant in the auxiliary pixel of the fourth color was 1% by mass and further the value (Y) of the auxiliary pixel of the fourth color was 88.2, so that the CF gave the best white balance.

In the CF of Comparative Example 1, the auxiliary pixel of the fourth color contained no colorant, and thus the CF was poor in white balance. In the CF of Comparative Example 2, the concentration of the colorant in the auxiliary pixel of the fourth color was 4% by mass, and thus the CF was poor in white balance and low in transmittance. In table 4 are shown the respective measurement values of the CF yielded in Example 1.

### Comparative Example 3

A CF was produced in the same way as in Example 1 except that when the BM was formed, the width of the unexposed portion (BM portion) of the positive mask was set to 6 μm, and that of the exposed portion (auxiliary pixel portion) was set to 34 μm.

### Examples 4 to 7

CFs were produced in such a manner that when their BM was formed, the respective widths of the unexposed portions and the exposed portions of their positive masks were variously changed.

In table 4 are shown the respective measurement values of the CFs yielded in Comparative Example 3 and Examples 4 to 7.

TABLE 4

| | Auxiliary pixel width (μm) 3W′ | | | | BM line width (μm) 2W′ | | | | | Opening width (μm) 4W′ | | | |
|---|---|---|---|---|---|---|---|---|---|---|---|---|---|
| | Red | Fourth | Blue | Green | 2-1 (L2) | 2-2 | 2-3 (L1) | 2-4 | L1/L2 | Red | Fourth | Blue | Green |
| Example 1 | 40.0 | 40.0 | 40.0 | 40.0 | 4.0 | 4.0 | 4.0 | 4.0 | 1 | 36.0 | 36.0 | 36.0 | 36.0 |
| Comparative | 40.0 | 40.0 | 40.0 | 40.0 | 6.0 | 6.0 | 6.0 | 6.0 | 1 | 34.0 | 34.0 | 34.0 | 34.0 |
| Example 3 | | | | | | | | | | | | | |
| Example 4 | 40.0 | 40.0 | 40.0 | 40.0 | 3.0 | 3.0 | 3.0 | 3.0 | 1 | 37.0 | 37.0 | 37.0 | 37.0 |
| Example 5 | 40.0 | 40.0 | 40.0 | 40.0 | 4.0 | 3.0 | 3.0 | 4.0 | 0.75 | 36.0 | 38.0 | 36.0 | 36.0 |
| Example 6 | 40.0 | 40.0 | 40.0 | 40.0 | 4.0 | 2.0 | 2.0 | 4.0 | 0.5 | 36.0 | 40.0 | 36.0 | 36.0 |
| Example 7 | 40.0 | 40.0 | 40.0 | 40.0 | 4.0 | 2.0 | 0.0 | 4.0 | 0 | 36.6 | 40.0 | 36.7 | 36.6 |

| | |
|---|---|
| On-BM-line width (μm) 5W′ | Aperture ratio (%) |

| | | | | |
|---|---|---|---|---|
| Red | Fourth (L3) | Blue | Green | Red, green |

| | 2-1 | 2-2 | 2-2 | 2-3 | 2-3 | 2-4 | 2-4 | 2-1 | and blue | Fourth |
|---|---|---|---|---|---|---|---|---|---|---|
| Example 1 | 2.0 | 2.0 | 2.0 | 2.0 | 2.0 | 2.0 | 2.0 | 2.0 | 67.5 | 22.5 |
| Comparative | 3.0 | 3.0 | 3.0 | 3.0 | 3.0 | 3.0 | 3.0 | 3.0 | 63.8 | 21.3 |
| Example 3 | | | | | | | | | | |
| Example 4 | 1.5 | 1.5 | 1.5 | 1.5 | 1.5 | 1.5 | 1.5 | 1.5 | 69.4 | 23.1 |
| Example 5 | 2.0 | 2.0 | 1.0 | 1.0 | 2.0 | 2.0 | 2.0 | 2.0 | 67.5 | 23.8 |
| Example 6 | 2.0 | 2.0 | 0 | 0 | 2.0 | 2.0 | 2.0 | 2.0 | 67.5 | 25.0 |
| Example 7 | 2.0 | 2.0 | 0 | 0 | 0 | 2.0 | 2.0 | 2.0 | 68.7 | 25.0 |

In Table 5 are shown various evaluation results of the CFs yielded in Example 1, Examples 4 to 7, and Comparative Example 3.

TABLE 5

| | | | | | | | | Total transmittance | | | |
|---|---|---|---|---|---|---|---|---|---|---|---|
| | | | | | | | | (“auxiliary pixel | | | |
| | | | | Auxiliary pixel | | | | transmittance” × | | | |
| | | | | transmittance (%) | | Auxiliary pixel | | “aperture | | | White |
| | | | | Additive | | aperture ratio | | ratio”/100) (%) | | | spots in |
| | | | | color | | (%) | | | | Red, green | red, green |
| | | | | mixture of | | Red, | | Red, | | and blue + | and blue |
| | White balance | | | red, green | Fourth | green | Fourth | green | Fourth | fourth | auxiliary |
| | \|Δx\| | \|Δy\| | Rating | and blue | color | and blue | color | and blue | color | color | pixels |
| Example 1 | 0.005 | 0.001 | Excellent | 25.9 | 88.2 | 67.5 | 22.5 | 17.5 | 19.8 | 37.4 | Good |
| Comparative | 0.005 | 0.001 | Excellent | 25.9 | 88.2 | 63.8 | 21.3 | 16.5 | 18.7 | 35.3 | Good |
| Example 3 | | | | | | | | | | | |
| Example 4 | 0.005 | 0.001 | Excellent | 25.9 | 88.2 | 69.4 | 23.1 | 18.0 | 20.4 | 38.4 | Good |
| Example 5 | 0.005 | 0.001 | Excellent | 25.9 | 88.2 | 67.5 | 23.8 | 17.5 | 20.9 | 38.5 | Good |
| Example 6 | 0.005 | 0.001 | Excellent | 25.9 | 88.2 | 67.5 | 25.0 | 17.5 | 22.1 | 39.6 | Good |
| Example 7 | 0.005 | 0.001 | Excellent | 25.9 | 88.2 | 68.8 | 25.0 | 17.8 | 22.1 | 39.9 | Good |

Example 1, Examples 4 to 7 and Comparative Example 3 are examples in which the BM line width 2W′ and the on-BM-line width L3 were each changed. As shown in Table 5, Example 1, Examples 4 to 8 and Comparative Example 3 were equal to one another in the composition used in each of the auxiliary pixels of red, green, blue and the fourth color, so as to be equal to one another in white balance and in auxiliary pixel transmittance.

In the CF of Example 1, the values L1 and L3 were 4.0 and 2.0 μm, respectively, and thus the respective aperture ratios of the auxiliary pixels could be heightened. In the CF of Example 1, the total transmittance of the auxiliary pixels of red, green, blue and the fourth color was as high as 37.4% and no white spots were generated in the auxiliary pixels of red, green and blue. Thus, the CF gave good results.

In the CF of Comparative Example 3, the values L1 and L3 were 6.0 μm and 3.0 μm, respectively, and thus the respective aperture ratios of the auxiliary pixels were low. In the CF of Comparative Example 3, the total transmittance of the auxiliary pixels of red, green, blue and the fourth color was as low as 35.3%. Thus, the CF gave bad results.

In the CF of Example 4, the values L1 and L3 were 3.0 μm and 1.5 μm, respectively, and thus the respective aperture ratios of the auxiliary pixels could be heightened. In the CF of Example 4, the total transmittance of the auxiliary pixels of red, green, blue and the fourth color was as high as 38.4% and no white spots were generated in the auxiliary pixels of red, green and blue. Thus, the CF gave good results.

Examples 1 and Examples 5 to 7 are examples in which the value L1 was changed. As the value L1 was smaller, the total transmittance was higher, so that a better result was obtained. In Examples 1 and Examples 5 to 7, white spots were not generated.

In the CF of Example 7, no BM was present between the auxiliary pixel of the fourth color and the blue auxiliary pixel, so that the auxiliary pixel of the fourth color partially overlapped with the blue auxiliary pixel. However, in each overlapping portion, the level difference was 0.3 μm or less, so that no problem was caused. In the CF of Example 4, the auxiliary pixel of the fourth color was light blue to be close in hue to the blue auxiliary pixel, so that the influence of color shift due to color mixture was small.

### Example 8

### Production of Liquid Crystal Display Device

TFT elements, transparent electrodes and others were formed on a non-alkali glass piece to produce an array substrate. Transparent electrodes were formed on each of this array substrate and the CF yielded in Example 1, and then a polyimide alignment film was formed thereon. The alignment film was subjected to rubbing treatment. Next, a sealing agent into which micro-rods were kneaded was printed onto the array substrate, and then bead spacers having a thickness of 6 μm were spread thereon. Thereafter, the array substrate and the CF were bonded to each other. A nematic liquid crystal (LIXSON (registered trade mark) JC-5007 LA, manufactured by Chisso Corp.) was injected through an injection hole provided in its sealing region. A polarizing film was then bonded onto each of both surfaces of the liquid crystal cell to make the polarization axis vertical. In this way, a liquid crystal panel was yielded. To this liquid crystal panel was fitted a two-wavelength backlight composed of a blue LED and a yellow phosphor. The chromaticity (x, y) of this two-wavelength backlight was (0.324, 0.330). Furthermore, TAB modules, a printed board and others were mounted thereon to produce a liquid crystal display device.

In this liquid crystal display device, white display was made. As a result, the display was uniform without having any unevenness. The white display chromaticity (x, y) of this liquid crystal display device was measured at 10 points thereof. As a result, the chromaticity (x, y) was in the range of 0.300≦x≦0.305 and 0.305≦y≦0.310. In the screen of the liquid crystal display device, the white display chromaticity was slight in unevenness. Thus, a good result was obtained.

### Comparative Example 4

### Production of Liquid Crystal Display Device

A liquid crystal display device was produced in the same way as in Example 8 except that the CF yielded in Comparative Example 1 was used.

In this liquid crystal display device, white display was made. As a result, the display was non-uniform with unevenness. The white display chromaticity (x, y) of this liquid crystal display device was measured at 10 points thereof. As a result, the chromaticity (x, y) was in the range of 0.300≦x≦0.324 and 0.305≦y≦0.326. In the screen of the liquid crystal display device, the white display chromaticity was large in unevenness. Thus, a bad result was obtained.

### Examples 9 to 12

A CF of each of Examples 9 to 12 was produced in the same way as in Example 1 except that the light-color colorant composition for the auxiliary pixel of the fourth color, and the film thickness of the auxiliary pixel of the fourth color were changed. Table 6 shows the compositions used to form the BM and the respective auxiliary pixels of the examples.

TABLE 6

| | Composition | Composition | Composition | Auxiliary pixel of fourth color | | | | |
|---|---|---|---|---|---|---|---|---|
| | for red | for green | for blue | | | Colorant | Film | |
| | auxiliary | auxiliary | auxiliary | | | concentration | thickness | Composition |
| | pixel | pixel | pixel | Composition | Colorant | (% by weight) | (μm) | for BM |
| Example 1 | Adjustment | Adjustment | Adjustment | Adjustment | PB15:6 | 1.0 | 2.0 | Adjustment |
| | Example 1 | Example 2 | Example 3 | Example 4 | | | | Example 9 |
| Example 9 | Adjustment | Adjustment | Adjustment | Adjustment | PB15:6 | 1.1 | 1.8 | Adjustment |
| | Example 1 | Example 2 | Example 3 | Example 11 | | | | Example 9 |
| Example | Adjustment | Adjustment | Adjustment | Adjustment | PB15:6 | 2.5 | 0.8 | Adjustment |
| 10 | Example 1 | Example 2 | Example 3 | Example 12 | | | | Example 9 |
| Example | Adjustment | Adjustment | Adjustment | Adjustment | PB15:6 | 2.9 | 0.7 | Adjustment |
| 11 | Example 1 | Example 2 | Example 3 | Example 13 | | | | Example 9 |
| Example | Adjustment | Adjustment | Adjustment | Adjustment | PB15:6 | 0.9 | 2.3 | Adjustment |
| 12 | Example 1 | Example 2 | Example 3 | Example 14 | | | | Example 9 |

In Table 7 are shown evaluation results of the respective values (x, y, Y) of the auxiliary pixels of red, green, blue and the fourth color.

TABLE 7

| | | | | | | | | | | Additive color | | | | | |
|---|---|---|---|---|---|---|---|---|---|---|---|---|---|---|---|
| | | | | | | | | | | mixture of red, | | | Pixel of fourth | | |
| | Red pixel | | | Green pixel | | | Blue pixel | | | green and blue | | | color | | |
| | x | y | Y | x | y | Y | x | y | Y | x | y | Y | x | y | Y |
| Example 1 | 0.630 | 0.311 | 19.6 | 0.223 | 0.601 | 43.6 | 0.134 | 0.120 | 14.7 | 0.280 | 0.302 | 25.9 | 0.285 | 0.303 | 88.2 |
| Example 9 | 0.630 | 0.311 | 19.6 | 0.223 | 0.601 | 43.6 | 0.134 | 0.120 | 14.7 | 0.280 | 0.302 | 25.9 | 0.285 | 0.303 | 88.6 |
| Example 10 | 0.630 | 0.311 | 19.6 | 0.223 | 0.601 | 43.6 | 0.134 | 0.120 | 14.7 | 0.280 | 0.302 | 25.9 | 0.285 | 0.303 | 88.7 |
| Example 11 | 0.630 | 0.311 | 19.6 | 0.223 | 0.601 | 43.6 | 0.134 | 0.120 | 14.7 | 0.280 | 0.302 | 25.9 | 0.285 | 0.303 | 88.7 |
| Example 12 | 0.630 | 0.311 | 19.6 | 0.223 | 0.601 | 43.6 | 0.134 | 0.120 | 14.7 | 0.280 | 0.302 | 25.9 | 0.285 | 0.303 | 86.8 |

In Table 8 are shown evaluation results of the respective white balances and transmittances of the CFs.

TABLE 8

| | | | | Pixel transmittance | | | |
|---|---|---|---|---|---|---|---|
| | | | | Additive color | | Color | Patterning |
| | White balance | | | mixture of red, | Fourth | reproduction | ability of pixels |
| | \|Δx\| | \|Δy\| | Rating | green and blue | color | range | of fourth color |
| Example 1 | 0.005 | 0.001 | Excellent | 25.9 | 88.2 | 70% | Good |
| Example 9 | 0.005 | 0.001 | Excellent | 25.9 | 88.6 | 70% | Good |
| Example 10 | 0.005 | 0.001 | Excellent | 25.9 | 88.7 | 70% | Good |
| Example 11 | 0.005 | 0.001 | Excellent | 25.9 | 88.7 | 70% | Allowable |
| Example 12 | 0.005 | 0.001 | Excellent | 25.9 | 86.8 | 70% | Good |

As shown in Tables 6 to 8, about the CFs of Example 1, and Examples 9 and 10, the film thickness of the auxiliary pixel of the fourth color was from 0.8 to 2.0 μm, and thus the transmittance of the auxiliary pixel of the fourth color was high. The pixel pattern of the fourth color was never chipped. Thus, good results were obtained. In Example 11, the film thickness of the pixel of the fourth color was 0.7 μm, and thus two sites of the pixel pattern of the fourth color were chipped. However, the chips were at such a level that no problem was caused. In Example 12, the film thickness of the pixel of the fourth color was 2.3 μM, and thus the pixel of the fourth color was decreased in transmittance. However, the decrease was at such a level that no problem was caused. The respective pixels of the fourth color of Example 1, and Examples 9 to 12 were equal to one another in chromaticity (x, y).

### Examples 13 to 16

A CF of each of Examples 13 to 16 was produced in the same way as in Example 1 except that the respective pixel widths and the respective pixel lengths of the auxiliary pixels of red, green, blue and the fourth color were changed. Table 9 shows results of the respective measurements.

TABLE 9

| | | | | | | | | | Pixel length (μm) |
|---|---|---|---|---|---|---|---|---|---|
| | Pixel width (μm) | | | | Pixel opening width (μm) | | | | Red, green, blue |
| | Red | Fourth | Blue | Green | Red | Fourth | Blue | Green | and fourth color |
| Example 1 | 40.0 | 40.0 | 40.0 | 40.0 | 36.0 | 36.0 | 36.0 | 36.0 | 160.0 |
| Example 13 | 30.0 | 30.0 | 30.0 | 30.0 | 26.0 | 26.0 | 26.0 | 26.0 | 120.0 |
| Example 14 | 20.0 | 20.0 | 20.0 | 20.0 | 16.0 | 16.0 | 16.0 | 16.0 | 80.0 |
| Example 15 | 10.0 | 10.0 | 10.0 | 10.0 | 6.0 | 6.0 | 6.0 | 6.0 | 40.0 |
| Example 16 | 8.0 | 8.0 | 8.0 | 8.0 | 4.0 | 4.0 | 4.0 | 4.0 | 32.0 |

| | | | | | Total | | | | |
|---|---|---|---|---|---|---|---|---|---|
| | | | | | area (μm²) | Aperture ratio (%) | | | |
| | | | | | BM + all | | | Red, green, | |
| | Opening area (μm²) | | | | auxiliary | Red, green | Fourth | blue and | Resolution |
| | Red | Fourth | Blue | Green | pixels | and blue | color | fourth color | (ppi) |
| Example 1 | 5760 | 5760 | 5760 | 5760 | 25600 | 67.5 | 22.5 | 90.0 | 159 |
| Example 13 | 3120 | 3120 | 3120 | 3120 | 14400 | 65.0 | 21.7 | 86.7 | 212 |
| Example 14 | 1280 | 1280 | 1280 | 1280 | 6400 | 60.0 | 20.0 | 80.0 | 318 |
| Example 15 | 240 | 240 | 240 | 240 | 1600 | 45.0 | 15.0 | 60.0 | 635 |
| Example 16 | 128 | 128 | 128 | 128 | 1024 | 37.5 | 12.5 | 50.0 | 794 |

As shown in Table 9, in the CFs of Examples 13 to 15, the area of the opening in each of the auxiliary pixels of red, green, blue and the fourth color was from 240 to 3120 μm². Thus, the total aperture ratio of the pixels of red, green, blue and the fourth color was 60% or more, and the resolution was 200 ppi or more, so that good results were obtained. In the CF of Example 16, the total aperture ratio was as low as 50%.

### REFERENCE SIGN LIST

1: Transparent substrate
2: BM
2-1: BM line (BM1) between green auxiliary pixel and red auxiliary pixel
2-2: BM line (BM2) between red auxiliary pixel and auxiliary pixel of fourth color
2-3: BM line (BM3) between auxiliary pixel of fourth color and blue auxiliary pixel
2-4: BM line (BM4) between blue auxiliary pixel and green auxiliary pixel
3: Auxiliary pixel
3-1: Red auxiliary pixel
3-2: Blue auxiliary pixel
3-3: Green auxiliary pixel
3-4: Auxiliary pixel of fourth color
2W: BM line width
3W: Auxiliary pixel width
4W: Opening width
5W: On-BM-line width

The CF of the present invention can be suitably used for display devices such as a liquid crystal display and an organic EL display.

1. A color filter in which a black matrix is formed on a transparent substrate, a pixel comprising a red auxiliary pixel, a green auxiliary pixel, a blue auxiliary pixel and an auxiliary pixel of a fourth color is formed at an opening in the black matrix, or at the opening in the black matrix and on the black matrix,
the line width L1 of the black matrix between the auxiliary pixel of the fourth color and each of other auxiliary pixels is from 0 to 4.5 μm, the auxiliary pixels each contain a colorant and a resin, and the tristimulus value (Y) of the auxiliary pixel of the fourth color according to the CIE 1931 color system is in the range of 70≦Y≦99.

2. The color filter according to claim 1, wherein the line width L1B of the black matrix between the auxiliary pixel of the fourth color and the blue auxiliary pixel is from 0 to 3.5 μm.

3. The color filter according to claim 1, wherein a relationship between the value L1 and the broadest line width L2 of the black matrix satisfies the following: 0≦L1/L2≦0.8.

4. The color filter according to claim 1, wherein in the pixel, the width L3 of the auxiliary pixel of the fourth color on the black matrix is from 0 to 2.0 μm.

5. The color filter according to claim 1, wherein the area of each of the auxiliary pixels of red, green, blue and the fourth color is from 240 to 3120 μm².

6. The color filter according to claim 1, wherein the concentration of the colorant in the auxiliary pixel of the fourth color is from 0.3 to 3% by mass.

7. The color filter according to claim 1, wherein the film thickness of the auxiliary pixel of the fourth color is from 0.8 to 2.0 μm.

8. The color filter according to claim 1, wherein the tristimulus value (Y) of the auxiliary pixel of the fourth color according to the CIE 1931 color system is in the range of 75≦Y≦90.

9. A display device comprising the color filter according to claim 1.
